(19) United States
(12) Patent Application Publication
(10) Pub. No.: US 2012/0299415 A1
(43) Pub. Date: Nov. 29, 2012

(54) DEVICE WITH INTEGRATED DECOUPLER

(76) Inventors: John R. Antchak, Innisfil (CA); Gary J. Spicer, Mississauga (CA)

(21) Appl. No.: 13/515,945

(22) PCT Filed: Dec. 16, 2010
(86) PCT No.: PCT/CA2010/002006

§ 371 Date: Jun. 14, 2012

Related U.S. Application Data
(60) Provisional application No. 61/286,878, filed on Dec. 16, 2009.

(51) Int. Cl. F16D 43/22; F16D 41/20; H02K 7/10; F16D 23/10

(52) U.S. Cl. 310/78; 192/103 R; 192/41 S; 192/55.1

(57) ABSTRACT

An accessory that include a machine, an input shaft, a drive member and a decoupler. The machine has a housing and a rotor that is supported for rotation in the housing. The machine effects work in response to driving rotation of the rotor. The input shaft is at least partly received in the housing. The drive member is coupled to the input shaft for common rotation and is configured to drivingly engage an endless power transmitting element to transmit rotary power between the endless power transmitting element and the input shaft. The decoupler is spaced axially apart from the drive member and couples the input shaft and the rotor in a mode that permits rotary power to be transmitted from the input shaft to the rotor in a predetermined rotational direction except when the input shaft decelerates relative to the rotor beyond a predetermined extent.

### INTRODUCTION

The present disclosure relates to a device or driven accessory that includes a machine, such as a generator or pump, that is driven by an endless power transmitting element, such as a gear, a belt or chain. More specifically, the present disclosure relates to a driven accessory with an integral decoupler.

Driven accessories that are driven by endless power transmitting elements (including flexible drives and gear train drives) are well known and widely employed. One common use of such arrangements is front engine accessory drive (FEAD) or rear engine accessory drive (READ) systems used in the automotive field. FEAD and/or READ systems typically comprise a drive, such as a belt or chain or a train of gears, connecting the crankshaft of the internal combustion engine of the vehicle and several accessories, such as alternators, water pumps, starter-generators, air conditioning compressors, power steering pumps, etc., which are driven by the crankshaft and, in some cases, which drive the crankshaft.

While such drive systems are widely employed, they do suffer from some problems. In particular, the sudden accelerations and decelerations of the engine crankshaft which occur due to the firing of the engine's cylinders manifest as undesired vibrations in the drive system and these undesired vibrations are typically referred to as torsional vibrations. Amongst other problems, torsional vibrations can lead to unacceptable operating noise and/or to damaging resonance within the engine under some conditions. Even when resonance is not occurring, torsional vibrations can decrease the operating lifetime of the drive and the accessories connected to it.

Operation of such drive systems can also be degraded when a driven accessory has sufficient inertia such that relatively large amounts of torque are transferred from the device to the drive (and hence to the crankshaft) when the engine decelerates. In particular, driven accessories, such as alternators, can have significant amounts of inertia that result in the transfer of large levels of torque, from the alternator to the crankshaft, through the drive when the engine decelerates.

To address these, and other, problems with such drive systems, it is known to employ decouplers, such as overrunning decouplers, to connect the driven accessories to the drive. Examples of decouplers include U.S. Pat. No. 6,083,130; Published PCT Application WO/04011818; and Published PCT Application WO/06081657 which are assigned to the assignee of the present disclosure. As is known, a decoupler provides a resilient connection between the drive and the driven device to reduce the effects of torsional vibration on the device. An overrunning decoupler includes a one-way clutch mechanism in addition to the resilient connection, which allows the device to overrun the drive during decelerations of the drive to reduce the transfer of torque from the device to the drive.

Decouplers have provided significant improvements for FEAD and READ systems. However, existing decouplers must be designed to fit into the gears, pulleys and/or sprockets (i.e., driven member) connecting the driven accessory to the drive. As the diameter of the driven member of the driven accessory is fixed by the desired ratio at which the driven member rotates with respect to the drive, the available space/volume for the decoupler mechanism within the driven member can be quite limited.

Accordingly, it would be desirable to incorporate the decoupler into the drive in a manner that may be packaged into the drive without regard for the volume of the drive member.

### SUMMARY

This section provides a general summary of the disclosure, and is not a comprehensive disclosure of its full scope or all of its features.

In one form, the present teachings provide a driven accessory that is configured to be driven by an endless power transmitting element. The driven accessory includes a machine, an input shaft, a drive member and a decoupler. The machine has a housing and a rotor that is supported for rotation in the housing. The machine effects or performs or produces work in response to driving rotation of the rotor. The input shaft is at least partly received in the housing. The drive member is coupled to the input shaft for common rotation and is configured to drivingly engage the endless power transmitting element to transmit rotary power between the endless power transmitting element and the input shaft. The decoupler couples the input shaft and the rotor in a mode that permits rotary power to be transmitted from the input shaft to the rotor in a predetermined rotational direction except when the input shaft decelerates relative to the rotor beyond a predetermined extent to thereby permit the rotor to rotate in the predetermined rotational direction relative to the input shaft. The decoupler is spaced axially apart from the drive member.

In another form, the present teachings provide a driven accessory that is configured to be driven by an endless power transmitting element. The driven accessory includes a generator, an input shaft and a decoupler. The generator has a housing and a hollow rotor that is supported for rotation in the housing. The input shaft is received in the hollow rotor. The decoupler couples the input shaft and the rotor in a manner that permits rotary power to be transmitted from the input shaft to the rotor in a predetermined rotational direction. The decoupler is configured to decouple the input shaft from the rotor to permit the rotor to overspeed the input shaft when the input shaft decelerates relative to the rotor beyond a predetermined extent.

By integrating the decoupler within the driven accessory, the decoupler can include components of larger size than prior art decouplers which were located with the input member.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way. Similar or identical elements are given consistent identifying numerals throughout the various figures.

FIG. 1 is a longitudinal cross section of a driven accessory contstructed in accordance with the present invention;

FIG. 2 is a view similar to that of FIG. 1 but illustrating the transmission of rotary power through the driven accessory;

FIG. 3 is a view similar to that of FIG. 1 but illustrating the transmission of rotary power through the driven accessory when a rotor of a machine of the driven accessory is overrunning a drive that is employed to power the machine;

FIG. 4 is a longitudinal cross section of a portion of another driven accessory constructed in accordance with the teachings of the present disclosure;

FIGS. 5a and 5b are exploded perspective views of exemplary decoupler assemblies suited for use with the portion of the driven accessory depicted in FIG. 4;

FIG. 6 is a longitudinal cross section view of the portion of the driven accessory of FIG. 4 with the decoupler assembly of FIG. 5a coupled thereto;

FIG. 7 is a perspective view of a portion of an alternately constructed decoupler assembly suited for use with the portion of the driven accessory depicted in FIG. 4;

FIG. 8 is a partial longitudinal cross section of an alternately constructed driven accessory that employs the decoupler of FIG. 7;

FIG. 9 is a schematic illustration of another driven accessory constructed in accordance with the teachings of the present disclosure, the driven accessory having a decoupler that is located outside a housing of a machine employs rotary power transmitted to produce or effect work;

FIG. 10 is a schematic illustration of a portion of still another driven accessory constructed in accordance with the teachings of the present disclosure, the driven accessory having a decoupler that is located radially between an input shaft and a rotor or secondary drive shaft; and

FIG. 11 is a longitudinal cross section view of the portion of yet another driven accessory constructed in accordance with the teachings of the present disclosure.

Corresponding reference numerals indicate corresponding parts throughout the several views of the drawings.

### DETAILED DESCRIPTION OF THE VARIOUS EMBODIMENTS

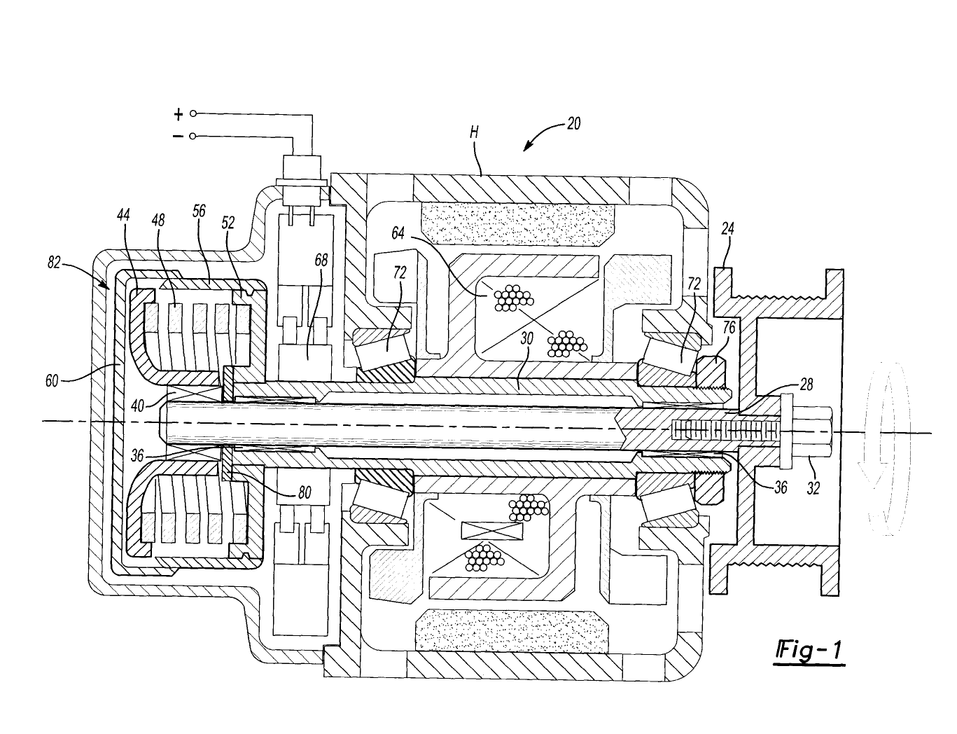

With reference to FIG. 1, a driven device constructed in accordance with the teachings of the present disclosure is generally indicated by reference numeral 20. Driven accessory 20 includes a machine which is depicted in the particular example provided as an alternator. Those of ordinary skill in the art will appreciate that the present teachings can be employed with various other types of machines, including pumps, fans, compressors. In this regard, it is contemplated that the present invention can be employed with substantially any driven device where it is desired to connect a rotor of a machine to a drive through a decoupler for driving the rotor of the machine to produce or effect work.

Driven accessory 20 includes a drive member, in the form of a pulley 24, to engage a flexible belt (not shown) of a drive. While driven accessory 20 is shown as being equipped with a pulley 24 as the drive member, the present disclosure is not so limited and the drive member can be a sprocket (to engage a drive comprising a chain), a gear (to engage a drive comprising a train of gears), or any other member suitable to engage the drive.

Pulley 24 is sized to an outer diameter such that pulley 24 will turn at a desired rotational speed with respect to the rotational speed of the drive. Pulley 24 is affixed to, and rotates with, an input shaft 28 of driven accessory 20. Pulley 24 can be affixed to input shaft 28 by any suitable means, such as by bolt 32.

Input shaft 28 is rotatably mounted concentrically (i.e., coaxially) within a hollow rotor or secondary drive shaft 30, discussed in more detail below, by a pair of bearing elements, such as bushings 36. Bushings 36 can be any suitable bushing type and design, as will occur to those of skill in the art. Additionally or alternatively, the bearing elements can be bearings or any other device that permits input shaft 28 to rotate with respect to secondary drive shaft 30.

The end of input shaft 28 opposite the end at which pulley 24 is affixed may be connected to a clutch, such as a one way clutch 40. In the example provided, one way clutch 40 provides overrunning functionality that permits torque or rotary power in a first rotational direction to be transferred from the drive, through pulley 24 to input shaft 28, while inhibiting the transfer of torque or rotary power in a second, opposite rotational direction from secondary drive shaft 30 to input shaft 28.

One-way clutch 40 is a sprag clutch in the particular example provided, but it will be appreciated that one way clutch 40 can be any suitable one way clutch mechanism, as will occur to those of skill in the art, and examples of such mechanisms include wire wrapped spring clutches, roller pin clutches, cam clutches, pawl and ratchet clutches, etc.

One-way clutch 40 acts between input shaft 28 and a hub 44 which is, in turn connected to one side of a resilient member. In the illustrated embodiment, the resilient member is a coil spring 48, one end of which engages hub 44, and the other end of which engages an annular driver 52 which is affixed to, and turns with, secondary drive shaft 30. Those of skill in the art will appreciate that it may be desirable to provide a clutch in lieu of one-way clutch 40 that permits operation in more than one mode (e.g., a one-way clutch mode for conventional operation, and a second mode, such as a locked mode in which the secondary shaft 30 and the input shaft 28 co-rotate). An alternative clutch arrangement may employ an electronic or electromagnetic actuator to control the mode in which the clutch operates. Such alternative clutch arrangements can be employed, for example, in situations where the alternator is employed as a starter motor. One exemplary clutch mechanism is described in International Patent Application Publication WO 03/104673 A1 entitled “Overrunning Enabled Automotive Starter/Generator”.

As will be apparent to those of skill in the art, the resilient member is not limited to being a coil spring and any other resilient member which can serve to dampen torsional vibrations through the resilient member, such as a rubber member or member formed of other resilient material, a torsion bar, etc. can be employed.

A cylindrical outer body 56 is affixed to hub 44 and, in combination with a cap 60 and hub 44, encloses coil spring 48 and one way clutch 40 to substantially prevent the ingress of foreign materials, such as dust or water, to coil spring 48 and one way clutch 40, and the egress of lubricants, such as grease or oil, from coil spring 48 and one way clutch 40 to the remainder of driven accessory 20. Cylindrical outer body 56 can be affixed to hub 44 by any suitable method, such as press fitting, and cap 60 can similarly be affixed to cylindrical outer body 56 by any suitable method such as press fitting.

Secondary drive shaft 30 functions in a similar manner to the drive shaft of a conventional alternator and has the windings 64 and brushes or slip rings 68 affixed to it, such that they rotate with secondary drive shaft 30.

Secondary drive shaft 30 can be rotatably mounted within driven accessory 20 by a set of bearing elements 72 and can be maintained in place by any suitable means, such as nut 76 and thrust washer 80.

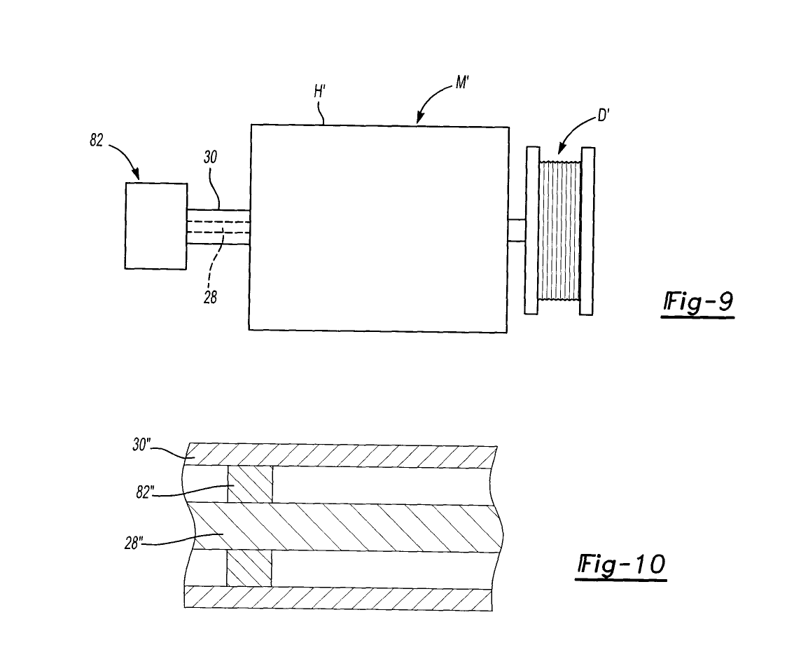

The assembly of one way clutch 40, hub 44, the resilient member (in this example coil spring 48, which is coaxial with input shaft 28) and annular driver 52, along with cylindrical outer body 56 and cap 60 is referred to herein as overrunning decoupler assembly 82. The overrunning decoupler assembly 82 is axially spaced apart from the drive member (e.g., pulley 84), such as on an end of the input shaft 28 opposite the drive member (pulley 24) that extends from the secondary drive shaft 30 such that the overrunning decoupler assembly couples the end of the input shaft 30 to the secondary drive shaft 30. In the particular example provided, the overrunning decoupler assembly is located in the housing H of the machine (e.g., alternator). Those of skill in the art will appreciate, however, that the overrunning decoupler assembly 82 could be packaged somewhat differently. For example, the overrunning decoupler assembly 82 could be disposed outside the housing H′ of the machine M′ on a side of the machine M′ opposite the drive member D′ as shown in FIG. 9. As another alternative, the overrunning decoupler assembly 82″ could be packaged radially between the input shaft 28″ and the secondary drive shaft 30″ as shown in FIG. 10.

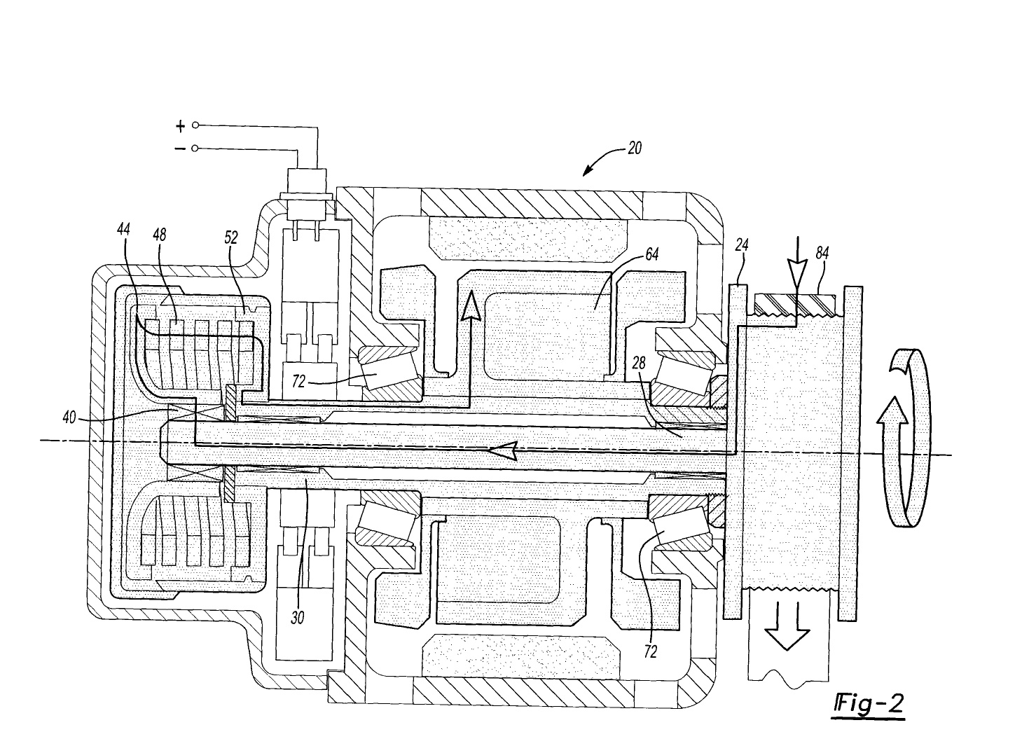

With reference to FIG. 2, torque or rotary power in the first rotational direction is applied by a belt 84 to the drive member (e.g., pulley 84) to cause the input shaft 28 to rotate in the first rotational direction. The one-way clutch 40 couples the input shaft 28 to the hub 44 to transmit the rotary power to the overrunning decoupler assembly 82. The rotary power is transmitted from the hub 44, through the resilient member (e.g., coil spring 48) to the annular driver 52. As the annular driver 52 is coupled for rotation with the secondary drive shaft 30, rotation of the annular driver 52 effects corresponding rotation of the secondary drive shaft 30 to thereby operate the machine (e.g., alternator) such that the machine produces or effects work (e.g., produces or effects electricity).

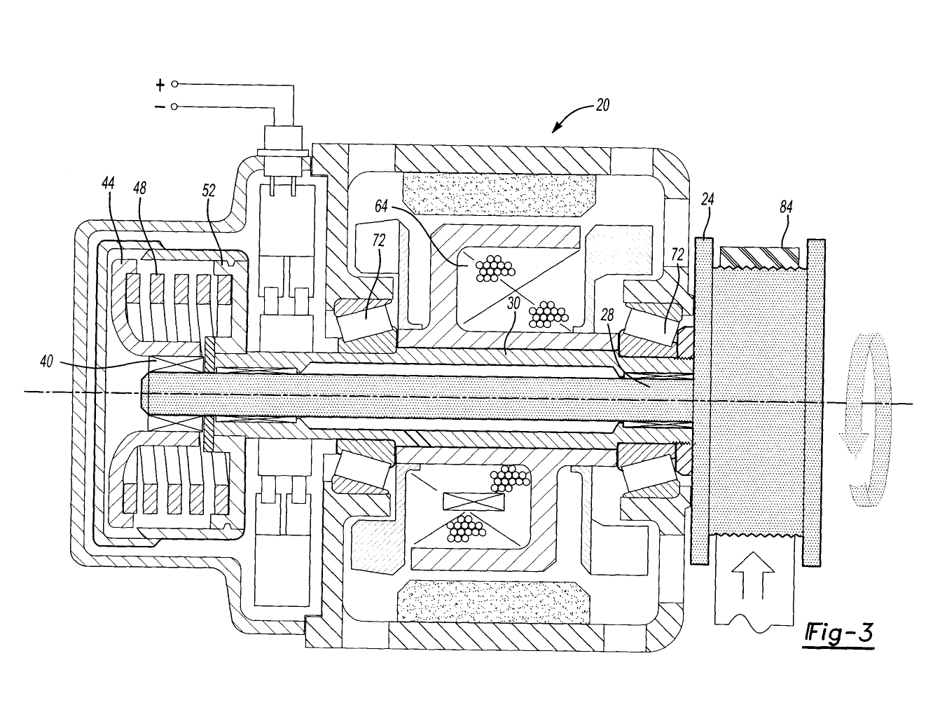

With reference to FIG. 3, operation of the driven accessory 20 in an overrunning condition is depicted. In contrast to the manner of operation described with respect to FIG. 2, the belt 84 has slowed somewhat so that the input shaft 28 has decelerated relative to the rotating components of the machine (e.g., alternator), including the secondary drive shaft 30, beyond a predetermined extent such that were the hub 44 rigidly or fixedly coupled to the input shaft 28, the rotational inertia of the rotating components of the machine would tend to permit the machine to back-drive the drive member. The one-way clutch 40, however, decouples the hub 44 from the input shaft 28 in such instances to permit the rotor or secondary drive shaft 30 to rotate in the first rotational direction at a speed in excess of that of the input shaft 28.

As input shaft 28 only rotates with respect to secondary drive shaft 30 a small amount as coil spring 48 is compressing and expanding to dampen torsional vibrations and when one way clutch 40 is free wheeling, i.e.—when overrunning is occurring, bushings 36 are sufficient to carry input shaft 28, without the need for more expensive and/or larger roller bearings or the like.

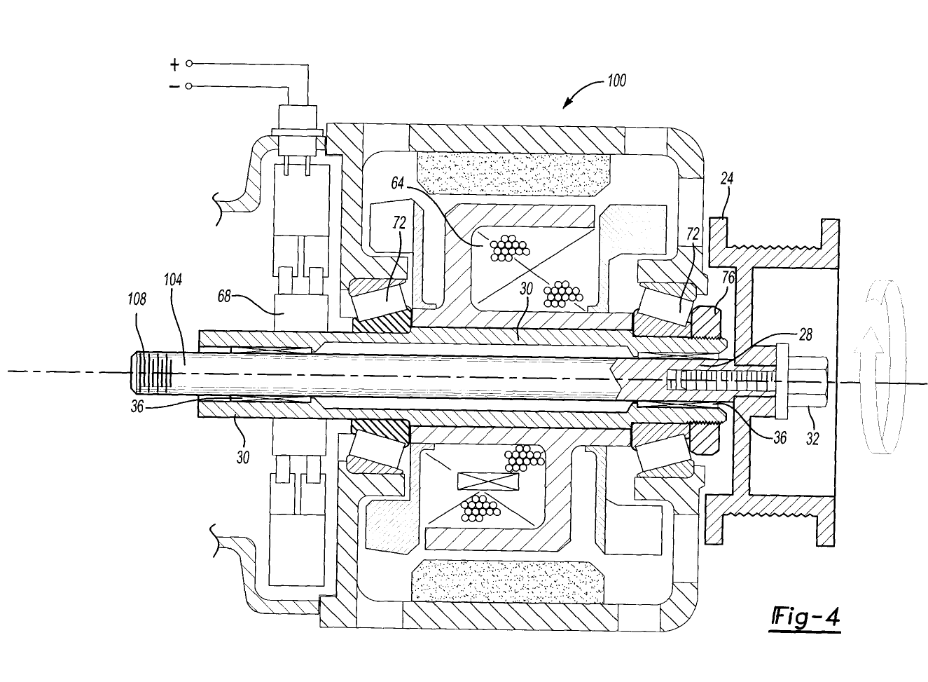

Another driven accessory constructed in accordance with the teachings of the present disclosure is shown in FIGS. 4 through 6 and is generally indicated by reference numeral 100, wherein like components to those of the embodiment of FIGS. 1 through 3 are indicated with like reference numerals. While driven accessory 100 is depicted as including a generator, it will be appreciated that the machine of the driven accessory 100 could comprise any type of machine that employs a rotary power input for producing or effecting work.

In FIG. 4, driven accessory 100 is shown prior to the attachment of an overrunning decoupler assembly, discussed below. In driven accessory 100, input shaft 104 is similar to input shaft 28, discussed above, but includes an end 108 to which the decoupler assembly is intended to be affixed.

In the illustrated embodiment, end 108 is shown as being threaded to receive the decoupler assembly. However, as will be apparent to those of skill in the art, end 108 can be configured to be affixed to the decoupler assembly in any suitable manner, including a splined connection, a welded connection or, in some circumstances, an interference (press fit) connection.

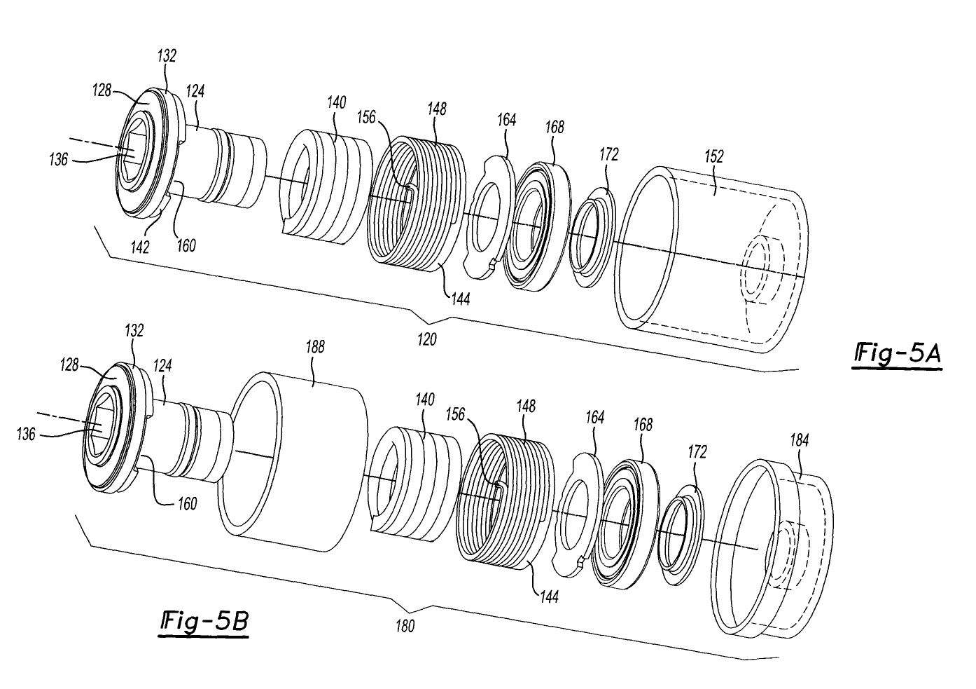

FIGS. 5a and 5b show examples of overrunning decoupler assemblies. With specific reference to FIG. 5a, overrunning decoupler assembly 120 is similar to the overrunning decoupler taught in U.S. Provisional Patent Application No. 61/108,600, filed Oct. 27, 2008 and entitled, “Over-Running Decoupler With Torque Limiter”, and in the corresponding PCT application filed Oct. 27, 2009, entitled “Method For Inhibiting Resonance In An Over-Running Decoupler” and the contents of these applications are incorporated herein by reference as if fully set forth in detail herein.

With additional reference to FIG. 4, overrunning decoupler assembly 120 includes a hub 124 which engages end 108 of input shaft 104 such that hub 124 will rotate with input shaft 104. Hub 124 can include a flange portion 128 with a bushing 132 located about the outer periphery and can include an installation feature 136, such as a hex keyway, that can receive a tool that can be employed to aid in the tightening of hub 128 to input shaft 104. Flange portion 128 further includes a stop 142, which abuts against one axial end face of a wire that forms a helical coil (torsion) spring 140, and a stop on a carrier 144 abuts against a second, opposite axial end face of the wire that forms the coil spring 140.

A wire wrap spring or wire wrap clutch 148 is coupled to clutch carrier 144. The wire wrap clutch 148 has an “at rest” outer diameter that is substantially the same as the diameter of the inner cylindrical surface of a clutch driver 152. The opposite end of wire wrap clutch 148 is formed into a tang 156 which is received in a slotted window 160 in flange portion 128. Wire wrap clutch 148 can have a suitable lubricant, such as an oil or grease applied to it.

A thrust washer 164 and a bearing 168 are located between carrier 144 the bottom of clutch driver 152 and these, and bushing 132, allow clutch driver 152 to rotate with respect to hub 124. A seal 172 can also be provided to prevent the ingress or egress of foreign materials and/or lubricants. Clutch driver 152 is affixed, by any suitable means such as welding, interference fit, etc. to secondary drive shaft 30 and rotates with it.

In FIG. 5b, an alternative decoupler assembly 180 is shown. Decoupler assembly 180 is constructed of similar components, indicated with like reference numerals, to those employed in decoupler assembly 120 with the difference that clutch driver 152 is replaced with a two part assembly of a clutch driver base 184 and a clutch driver cylinder 188 which are affixed to each other by any suitable means. It is contemplated that, in some circumstances, it may be desirable to employ a two part (184, 188) clutch driver to reduce manufacturing costs and/or to allow hardening, or other manufacturing processes, to be more easily performed on the parts.

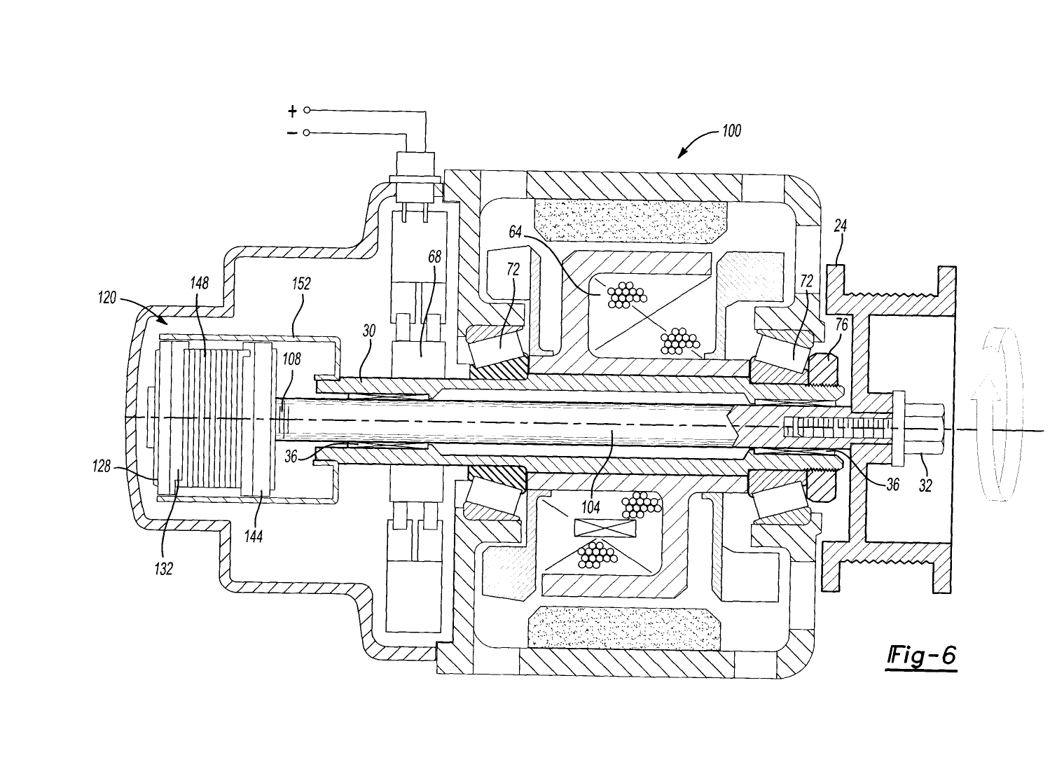

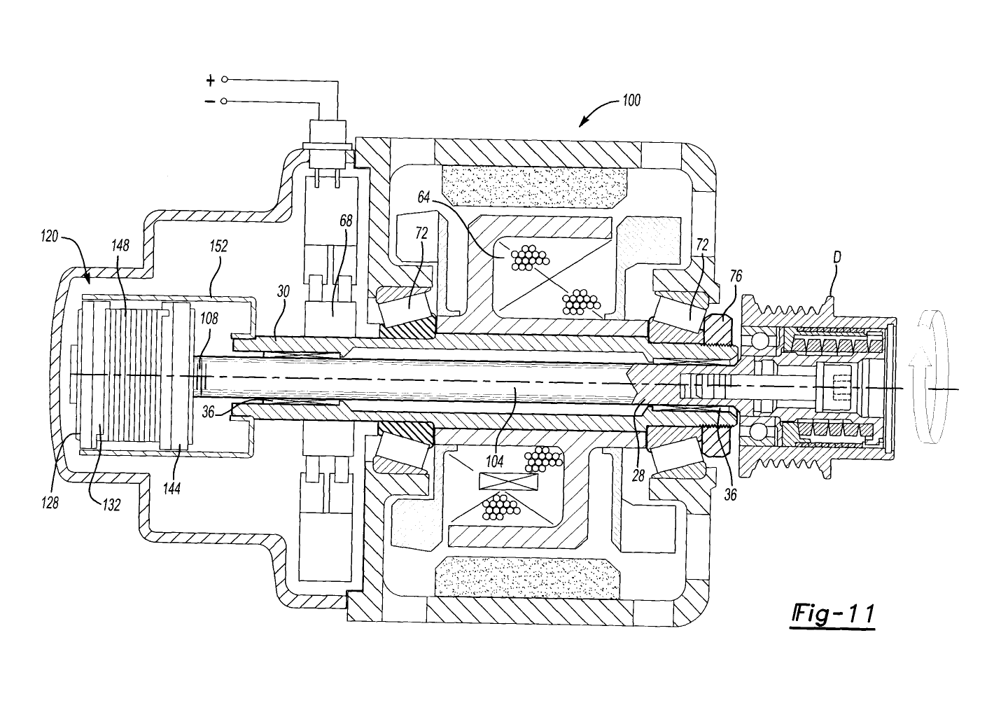

FIG. 6 shows decoupler assembly 120 installed on driven accessory 100 and decoupler assembly 180 can be installed in a same manner. If desired, the driven accessory could include the decoupler assembly 120, as well as a conventional decoupler D that can be mounted directly to the input shaft 28 as is shown in FIG. 11. The conventional decoupler D is described in detail in International Publication WO 2006/081657, the disclosure of which is incorporated by reference as if fully set forth in detail herein.

Returning to FIG. 6, when torque is applied to pulley 24, and hence to input shaft 104, hub 124 applies that torque to coil spring 140 which, in turn applies the torque to carrier 144. Carrier 144 applies that torque to the end of wire wrap clutch 148, causing wire wrap clutch 148 to slightly expand its outer diameter, bringing it into frictional engagement with the interior surface of clutch driver 152 (or 184 and 188), effectively locking wire wrap clutch 148 to lock to, and rotate with, clutch driver 152 (or 184 and 188). As the torque is applied to clutch driver 152 (or 184 and 188), that torque is then applied to secondary drive shaft 30 to rotate rotor and windings 64 of driven accessory 100.

In the event that driven accessory 100 is to overrun pulley 24, torque is applied from secondary drive shaft 30 to clutch driver 152 (or 184 and 188) and thus to wire wrap clutch 148. The torque applied to the windings of wire wrap clutch 44 by clutch driver 152 (or 184 and 188) cause the outer diameter of wire wrap clutch 148 to be reduced, allowing wire wrap clutch 148 to rotate within clutch driver 152 (or 184 and 188), thus preventing the transfer of torque to input shaft 108 and allowing driven accessory 100 to overrun pulley 24.

In the illustrated embodiment, decoupler assemblies 120 and 180 also provide the torque limiting function (i.e., decoupler assemblies 120 and 180 can additionally operate as a torque clutch) described in detail in the above-mentioned U.S. Provisional Patent Application and PCT Patent Application. Specifically, tang 156 of wire wrap clutch 148 is received in slotted window 160 of hub 124. If the torque applied to input shaft 108 exceeds a pre-selected maximum, the rotational displacement of hub 124 with respect to clutch driver 152 (or 184 and 188) due to the loading on coil spring 140 will cause tang 156 to abut the end of slotted window 160. This results in the outer diameter of wire wrap clutch 148 being reduced, thus allowing clutch driver 152 (or 184 and 188) to “slip” with respect to wire wrap clutch 148 and input shaft 108. Once the torque applied to input shaft 108 is reduced to a value below the pre-selected value, tang 156 moves away from the end of slotted window 160 and wire wrap clutch 148 expands again, locking it to clutch driver 152 (or 184 and 188) to again allow the transfer of torque from input shaft 108 to secondary drive shaft 30.

It should be appreciated that while the overrunning decoupler assemblies 120, 180 are described herein as having a torque limiting function as described above, such function is not required by the present disclosure and can be omitted, if desired.

As should now be apparent to those of skill in the art, by integrating the decoupler with the device, many of the issues which arose in the prior art, wherein the decoupler was located within the pulley, can be avoided. In particular, by separating the decoupler and the pulley, the outer diameter and/or length of the decoupler is no longer limited to fitting inside the pulley. This allows for one way clutches with larger diameters and/or lengths to be employed, with a commensurate increase in the longevity of the one way clutch and an increase in its torque transferring capabilities and/or a decrease in the manufacturing cost of the one way clutch. Similarly, the resilient member of the decoupler can have a larger diameter or length and, if a coil spring, can have thicker windings or more windings. Also, the use of resilient members, other than coil springs, is now easier as larger rubber (or other resilient material) components can be employed.

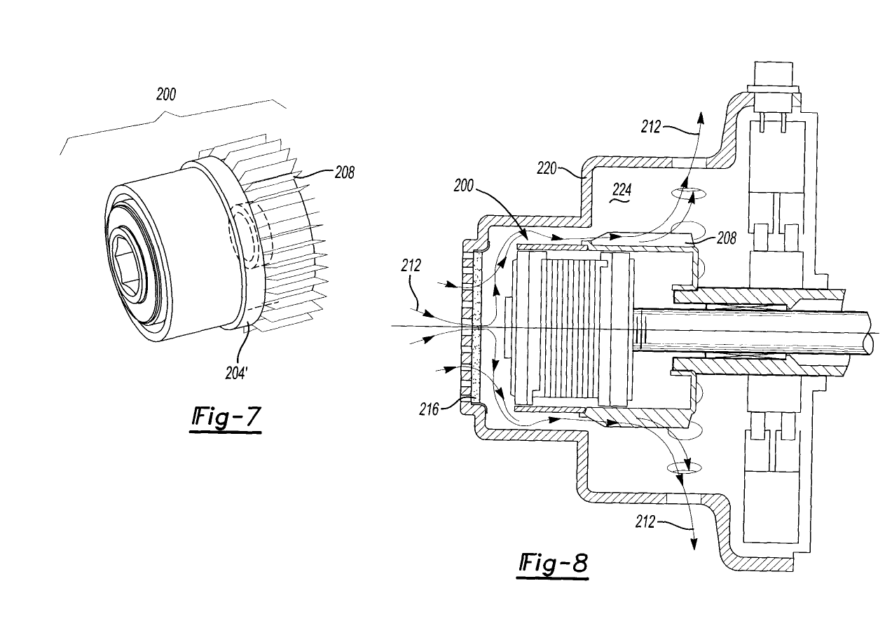

In contrast to prior art decouplers, which are commonly integrated into a drive member, such as a pulley, the decoupler assemblies of the present disclosure can be larger, allowing for enhanced passive cooling of the components and the components, such as the clutch driver cylinder, can also be provided with features, such a knurls or fins, to increase their surface area to enhance their cooling. Further, it is contemplated that active cooling can also be provided. For example, FIG. 7 shows another embodiment of a decoupler assembly 200, which is similar to decoupler assembly 180, but wherein the clutch driver base 204′ includes a set of impellor fins 208 to create a cooling air flow when decoupler assembly 200 is rotating. While the fins 208 are depicted as flat and extending solely in a radially outwardly direction from the remainder of the clutch driver base 204′, it will be appreciated that the fins 208 could be shaped in a desired manner (e.g., helically).

FIG. 8 shows the cooling airflow (indicated by the arrows 212) created by impellor fins 208 when decoupler assembly 200 is installed and operating on a device. A filter element 216 can be provided in the device housing 220 to prevent the ingress of foreign material with cooling air 212.

In FIG. 8, the volume 224 within device housing 220 is shown to be open to the interior volume of the remainder of the device. However, as will be apparent to those of skill in the art, if desired a suitable barrier (not shown) can be provided between volume 224 and the remainder of the interior of the device to isolate the cooling airflow 212 from the temperatures with the remainder of the device.

As an additional enhancement to the cooling of the decoupler, it is contemplated that the clutch driver, and/or other components, can be treated to enhance their radiation of waste heat to the surrounding air. For example, coatings such as the TLTD Thermal Dispersant coating, manufactured by Tech Line Coatings, Inc., 26844 Adams Ave., Murrieta, Calif., USA, 92562 can be applied to the clutch driver and/or other components.

It is also contemplated that, due to the enhanced ability to cool the decoupler, a wider range of constructions, in addition to coil springs, can be employed for the resilient member in the decoupler. For example, a rubber or rubber-like elements can more easily be employed as the expected operating temperature range can be better managed.

As will be apparent to those of skill in the art, in the case wherein the device of the present disclosure is water, or oil, cooled, the decoupler assembly can also be cooled by that water or oil supply, thus further enhancing the cooling of the decoupler.

While in the embodiments described above all of the elements of the decoupler are located at the opposite side of the device from the input member (i.e.—pulley 24), the present disclosure is not so limited and it is contemplated that elements of the decoupler can be located at different parts of the device. For example, if the one-way clutch is a sprag clutch or the like, it can be located in the device adjacent to pulley 24 while the resilient member can be located in the device at the opposite end. Alternatively, if sufficient volume is available in a particular application, all of the components of the decoupler can be located in the device adjacent the end where the input member is located.

It is further contemplated that the present disclosure can be employed in combination with prior art decoupler mechanisms. For example, pulley 24 on driven accessory 100 can be replaced by a prior art isolator which provides some degree of isolation from torsional vibration. In such a case, the prior art isolator can be designed to provide isolation within a first frequency range while resilient member 140 of decoupler assembly 120 (or 180) can be selected to provide isolation in a second frequency range. This can be useful, for example, in cases such as military uses where a vehicle can be driven as a vehicle in the normal manner and will be subject to resonances at one frequency range and where that vehicle can be stopped but acting as a generator for other equipment and the engine of the vehicle will be driving a large generator and inverter and will thus be operating under different conditions and will be subject to resonances at a second, different, frequency range.

Similarly, pulley 24 on driven accessory 20 can be replaced by a prior art decoupler which provides both isolation in a first frequency band and a one-way clutch. In such a case, one way clutch 40 may be omitted, or included to provide redundancy or to provide addition load carrying capacity, while resilient member 48 can be designed to provide isolation in a different frequency band than the resilient member in the prior art decoupler

As will now be apparent, the present disclosure provides a device to be connected to a drive wherein the connection to the drive is by way of a decoupler integrated within the device. An input member, such as a pulley or sprocket, connects the device to the drive, such as a flexible belt or chain or a train of gears, and the input member is connected to a first input shaft which is connected to the decoupler. A secondary drive shaft is also connected to the decoupler and to the load, such as the rotor of an alternator, within the device. The decoupler operates to allow the transfer of torque between the first input shaft and the secondary drive shaft.

Preferably, the decoupler provides both isolation from torsional vibrations in the drive and provides overrunning functions to allow the device to overrun the drive. Also preferably, the device includes a torque limiting feature which operates to limit the amount of torque which can be input to the device by the drive.

By integrating the decoupler within the device, the decoupler can include components of larger size than prior art decouplers which were located with the input member and enhanced cooling can be available to the decoupler of the present disclosure compared to prior art decouplers located within input members such as pulleys.

While the illustrated examples of the driven accessory employ a particular type of decoupler (i.e., an overrunning decoupler), it will be appreciated that the teachings of the present disclosure have broader application and that the decoupler could be of the type that does not facilitate the overrunning of the rotor of the machine. Examples of such “non-overrunning” or plain decouplers can be found in U.S. Pat. Nos. 7,153,227 and 7,227,910, the disclosures of which are hereby incorporated by reference as if fully set forth in detail herein. As another example, if overrunning of the rotor of the machine is not desired but rather only torsional damping or isolation, the one-way clutch 40 may be omitted from the example depicted in FIG. 1 and the hub 44 can be directly coupled to the input shaft 28.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims.

1. A driven accessory that is configured to be driven by an endless power transmitting element, the driven accessory comprising:
a machine having a housing and a rotor that is supported for rotation in the housing, the machine effecting work in response to driving rotation of the rotor;
an input shaft at least partly received in the housing;
a drive member coupled to the input shaft for common rotation, the drive member being adapted to drivingly engage the endless power transmitting element to transmit rotary power between the endless power transmitting element and the input shaft; and
a decoupler coupling the input shaft and the rotor in a mode that permits rotary power to be transmitted from the input shaft to the rotor in a predetermined rotational direction except when the input shaft decelerates relative to the rotor beyond a predetermined extent to thereby permit the rotor to rotate in the predetermined rotational direction relative to the input shaft;
wherein the decoupler is spaced axially apart from the drive member.

2. The driven accessory of claim 1, wherein the input shaft and the rotor are disposed coaxially.

3. The driven accessory of claim 2, wherein the input shaft is supported for rotation within the rotor.

4. The driven accessory of claim 1, wherein the decoupler is disposed radially between the input shaft and the rotor.

5. The driven accessory of claim 3, wherein an end of the input shaft extends from the rotor and wherein the decoupler couples the end of the input shaft to the rotor.

6. The driven accessory of claim 5, wherein the decoupler and the drive member are coupled to opposite ends of the input shaft.

7. The driven accessory of claim 1, wherein the decoupler is received in the housing.

8. The driven accessory of claim 1, wherein the decoupler comprises a hub and a driver and a spring disposed between the hub and the driver.

9. The driven accessory of claim 8, wherein the decoupler further comprises a one-way clutch between the hub and the input shaft, the one-way clutch permitting rotation of the hub relative to the input shaft in the first rotational direction and inhibiting rotation of the hub relative to the input shaft in a second rotational direction opposite the first rotational direction.

10. The driven accessory of claim 9, wherein the one-way clutch is a sprag clutch or a wrap spring clutch.

11. The driven accessory of claim 8, wherein the spring is a helical torsion spring that is coaxial with the input shaft.

12. The driven accessory of claim 1, wherein the decoupler comprises a torque clutch that limits a torque that is transmitted between the input shaft and the rotor.

13. The driven accessory of claim 1, wherein the machine is a generator.

14. A driven accessory that is configured to be driven by an endless power transmitting element, the driven accessory comprising:
a generator having a housing and a hollow rotor that is supported for rotation in the housing;
an input shaft received in the hollow rotor; and
a decoupler coupling the input shaft and the rotor in a manner that permits rotary power to be transmitted from the input shaft to the rotor in a predetermined rotational direction, the decoupler being configured to decouple the input shaft from the rotor to permit the rotor to overspeed the input shaft when the input shaft decelerates relative to the rotor beyond a predetermined extent.

15. The driven accessory of claim 14, wherein the decoupler is disposed radially between the input shaft and the rotor.

16. The driven accessory of claim 14, wherein an end of the input shaft extends from the rotor and wherein the decoupler couples the end of the input shaft to the rotor.

17. The driven accessory of claim 14, further comprising a drive member coupled to the input shaft for common rotation, the drive member being adapted to drivingly engage the endless power transmitting element to transmit rotary power between the endless power transmitting element and the input shaft.

18. The driven accessory of claim 17, wherein the decoupler and the drive member are coupled to opposite ends of the input shaft.

19. The driven accessory of claim 14, wherein the decoupler is received in the housing.

20. The driven accessory of claim 14, wherein the decoupler comprises a hub, a driver, a spring, and a one-way clutch that couples the hub to the input shaft, the driver being coupled to the rotor, the spring being disposed between the hub and the driver to attenuate torsional vibration transmitted through the decoupler, the one-way clutch being disposed between the hub and the input shaft, the one-way clutch permitting rotation of the hub relative to the input shaft in the first rotational direction and inhibiting rotation of the hub relative to the input shaft in a second rotational direction opposite the first rotational direction.

21. The driven accessory of claim 14, wherein the decoupler comprises a torque clutch that limits a torque that is transmitted between the input shaft and the rotor.

22. The driven accessory of claim 14, wherein the decoupler comprises a plurality of fins that are configured to generate an flow of air during operation of the driven accessory.
